(19) United States
(12) Patent Application Publication
(10) Pub. No.: US 2017/0337062 A1
(43) Pub. Date: Nov. 23, 2017

(54) SINGLE-THREAD SPECULATIVE MULTI-THREADING

(71) Applicant: Centipede Semi Ltd., Netanya (IL)

(72) Inventors: Jonathan Friedmann, Even Yehuda (IL); Shay Koren, Tel-Aviv (IL); Noam Mizrahi, Hod Hasharon (IL); Alberto Mandler, Zichron Yaakov (IL)

(21) Appl. No.: 15/393,291

(22) Filed: Dec. 29, 2016

Related U.S. Application Data
(60) Provisional application No. 62/338,557, filed on May 19, 2016.

(51) Int. Cl. G06F 9/38; G06F 9/30

(52) U.S. Cl. CPC G06F 9/3814; G06F 9/3005; G06F 9/3867

(57) ABSTRACT

A processor includes a pipeline and control circuitry. The pipeline is configured to process instructions of program code and includes one or more fetch units. The control circuitry is configured to predict at run-time one or more future flow-control traces to be traversed in the program code, to define, based on the predicted flow-control traces, two or more regions of the program code from which instructions are to be fetched, wherein the number of regions is greater than the number of fetch units, and to instruct the pipeline to fetch instructions alternately from the two or more regions of the program code using the one or more fetch units, and to process the fetched instructions.

### CROSS-REFERENCE TO RELATED APPLICATIONS

This application claims the benefit of U.S. Provisional Patent Application 62/338,557, filed May 19, 2016, whose disclosure is incorporated herein by reference.

### FIELD OF THE INVENTION

The present invention relates generally to processor design, and particularly to methods and systems for run-time code parallelization.

### BACKGROUND OF THE INVENTION

Various techniques have been proposed for dynamically parallelizing software code at run-time. For example, Marcuellu et al., describe a processor microarchitecture that simultaneously executes multiple threads of control obtained from a single program by means of control speculation techniques that do not require compiler or user support, in “Speculative Multithreaded Processors,” Proceedings of the 12^{th} International Conference on Supercomputing, 1998, which is incorporated herein by reference.

### SUMMARY OF THE INVENTION

An embodiment of the present invention that is described herein provides a processor including a pipeline and control circuitry. The pipeline is configured to process instructions of program code and includes one or more fetch units. The control circuitry is configured to predict at run-time one or more future flow-control traces to be traversed in the program code, to define, based on the predicted flow-control traces, two or more regions of the program code from which instructions are to be fetched, wherein the number of regions is greater than the number of fetch units, and to instruct the pipeline to fetch instructions alternately from the two or more regions of the program code using the one or more fetch units, and to process the fetched instructions.

In some embodiments, the control circuitry is configured to hold, at any given time, identifiers of the two or more regions, and to instruct the one or more fetch units to fetch instructions from a partial subset of the two or more regions in a given clock cycle.

In an embodiment, in any clock cycle of the processor fetching is performed from only one of the regions per any one of the fetch units. In a disclosed embodiment, the number of fetch units is 1 and the number of regions is 2. In an example embodiment, the control circuitry is configured to instruct the fetch units to fetch the instructions in an order, which differs from an actual order of processing of the instructions determined by an actual flow control through the program code.

In another embodiment, the control circuitry is configured to assign one of the regions higher priority than another of the regions in fetching the instructions. In yet another embodiment, the control circuitry is configured to identify that fetching from one of the regions is stalled or is predicted to be stalled for at least one clock cycle, and in response instruct the fetch units to fetch only instructions from other regions. In an embodiment, in any clock cycle the pipeline is configured to decode, per fetch unit, only instructions belonging to the same region. In an embodiment, in any clock cycle the pipeline is configured to rename, per fetch unit, only instructions belonging to the same region.

In some embodiments, the pipeline includes a respective reorder buffer (ROB) for each of the regions. In alternative embodiments, the pipeline includes a reorder buffer (ROB) that is shared by at least two of the regions. In an embodiment, the two or more regions include a first region, and a second region that occurs later in the program code than the first region, and the control circuitry is configured to identify a branch mis-prediction in the second region, and in response flush from the pipeline the instructions that follow the branch mis-prediction in the second region, but retain the instructions of the first region in the pipeline.

In some embodiments, the pipeline includes a separate set of execution units for each of the regions. In other embodiments, the pipeline includes a set of execution units that is shared by at least two of the regions. In an example embodiment, the pipeline includes a register file that is shared by at least two of the regions.

In a disclosed embodiment, the control circuitry is configured to decide to switch from fetching the instructions from a first region to fetching the instructions from a second region in response to a stall or predicted stall on a resource in the first region. In another embodiment, the control circuitry is configured to decide to switch from fetching the instructions from a first region to fetching the instructions from a second region in response to an indication that the second region belongs to a critical execution path. In yet another embodiment, the control circuitry is configured to decide to switch from fetching the instructions from a first region to fetching the instructions from a second region in accordance with a predefined fairness criterion.

There is additionally provided, in accordance with an embodiment of the present invention, a method including, in a processor that processes instructions of program code and includes one or more fetch units, predicting at run-time one or more future flow-control traces to be traversed in the program code. Two or more regions of the program code, from which instructions are to be fetched, are defined based on the predicted flow-control traces, wherein the number of regions is greater than the number of fetch units. Instructions are fetched alternately from the two or more regions of the program code using the one or more fetch units, and the fetched instructions are processed.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a processor, in accordance with an embodiment of the present invention;

FIG. 2 is a flow chart that schematically illustrates a method for speculative multi-threading, in accordance with an embodiment of the present invention; and

FIGS. 3-6 are block diagrams that schematically illustrate processor pipelines, in accordance with embodiments of the present invention.

### DETAILED DESCRIPTION OF EMBODIMENTS

### Overview

Embodiments of the present invention that are described herein provide improved methods and systems for run-time parallelization of code in a processor. In particular, the disclosed techniques carry out speculative multi-threading over multiple code segments in parallel, using a pipeline having fewer fetch units than the number of code segments being processed. Reducing the number of fetch units helps to reduce the physical size, power consumption and cost of the processor.

In some embodiments, a processor comprises a pipeline comprising M fetch units, M≧1, and control circuitry that controls the pipeline. The control circuitry predicts, at run-time, one or more future flow-control traces that are expected to be traversed in the program code. Based on the trace prediction, the control circuitry specifies a total of N regions of the code in which instructions are to be processed, N>M. The regions are also referred to herein as segments.

The control circuitry instructs the pipeline to fetch instructions alternately from the N segments using the M fetch units (M<N), and to process the fetched instructions. The instructions are thus fetched in an order that differs from the order-of-appearance of the instructions in the program code.

Various examples of pipeline structures that can be used with the disclosed techniques are described. Example criteria for switching fetch units from one region to another are also described.

### System Description

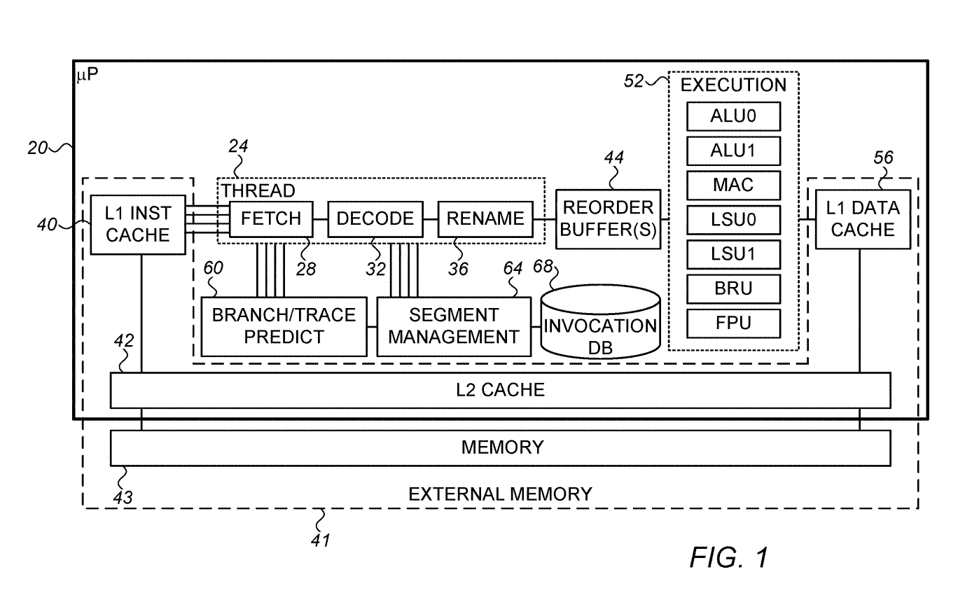

FIG. 1 is a block diagram that schematically illustrates a processor 20, in accordance with an embodiment of the present invention. In the present example, processor 20 comprises a hardware thread 24 that is configured to process multiple code segments in parallel using techniques that are described in detail below. In alternative embodiments, processor 20 may comprise multiple threads 24. Certain aspects of code parallelization are addressed, for example, in U.S. patent application Ser. Nos. 14/578,516, 14/578,518, 14/583,119, 14/637,418, 14/673,884, 14/673,889, 14/690,424, 14/794,835, 14/924,833, 14/960,385, 15/077,936 and 15/196,071, which are all assigned to the assignee of the present patent application and whose disclosures are incorporated herein by reference.

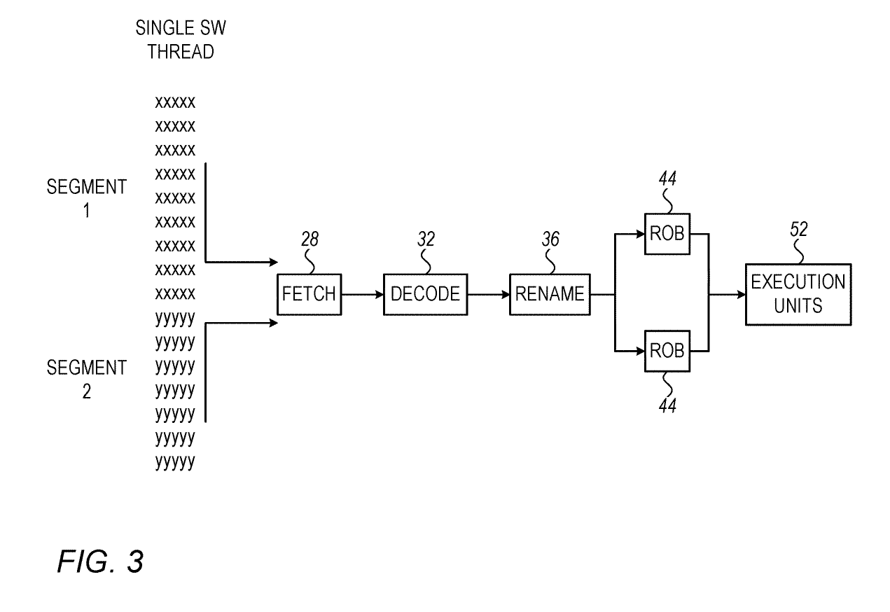

In the present embodiment, thread 24 comprises one or more fetching modules 28, one or more decoding modules 32 and one or more renaming modules 36 (also referred to as fetch units, decoding units and renaming units, respectively). Several example configurations are depicted in FIGS. 3-6 below.

Fetching modules 28 fetch instructions of program code from a memory, e.g., from a multi-level instruction cache. In the present example, processor 20 comprises a memory system 41 for storing instructions and data. Memory system 41 comprises a multi-level instruction cache comprising a Level-1 (L1) instruction cache 40 and a Level-2 (L2) cache 42 that cache instructions stored in a memory 43. Decoding modules 32 decode the fetched instructions.

Renaming modules 36 carry out register renaming. The decoded instructions provided by decoding modules 32 are typically specified in terms of architectural registers of the processor's instruction set architecture. Processor 20 comprises a register file that comprises multiple physical registers. The renaming modules associate each architectural register in the decoded instructions to a respective physical register in the register file (typically allocates new physical registers for destination registers, and maps operands to existing physical registers).

The renamed instructions (e.g., the micro-ops/instructions output by renaming modules 36) are buffered in-order in one or more Reorder Buffers (ROB) 44, also referred to as Out-of-Order (OOO) buffers. In alternative embodiments, one or more instruction queue buffers are used instead of ROB. The buffered instructions are pending for out-of-order execution by multiple execution modules 52, i.e., not in the order in which they have been fetched. In alternative embodiments, the disclosed techniques can also be implemented in a processor that executes the instructions in-order.

The renamed instructions buffered in ROB 44 are scheduled for execution by the various execution units 52. Instruction parallelization is typically achieved by issuing one or multiple (possibly out of order) renamed instructions/micro-ops to the various execution units at the same time. In the present example, execution units 52 comprise two Arithmetic Logic Units (ALU) denoted ALU0 and ALU1, a Multiply-Accumulate (MAC) unit, two Load-Store Units (LSU) denoted LSU0 and LSU1, a Branch execution Unit (BRU) and a Floating-Point Unit (FPU). In alternative embodiments, execution units 52 may comprise any other suitable types of execution units, and/or any other suitable number of execution units of each type. The cascaded structure of threads 24 (including fetch modules 28, decoding modules 32 and renaming modules 36), ROB 44 and execution units 52 is referred to herein as the pipeline of processor 20.

The results produced by execution units 52 are saved in the register file, and/or stored in memory system 41. In some embodiments the memory system comprises a multi-level data cache that mediates between execution units 52 and memory 43. In the present example, the multi-level data cache comprises a Level-1 (L1) data cache 56 and L2 cache 42.

In some embodiments, the Load-Store Units (LSU) of processor 20 store data in memory system 41 when executing store instructions, and retrieve data from memory system 41 when executing load instructions. The data storage and/or retrieval operations may use the data cache (e.g., L1 cache 56 and L2 cache 42) for reducing memory access latency. In some embodiments, high-level cache (e.g., L2 cache) may be implemented, for example, as separate memory areas in the same physical memory, or simply share the same memory without fixed pre-allocation.

A branch/trace prediction module 60 predicts branches or flow-control traces (multiple branches in a single prediction), referred to herein as “traces” for brevity, that are expected to be traversed by the program code during execution by the various threads 24. Based on the predictions, branch/trace prediction module 60 instructs fetching modules 28 which new instructions are to be fetched from memory. Typically, the code is divided into regions that are referred to as segments; each segment comprises a plurality of instructions; and the first instruction of a given segment is the instruction that immediately follows the last instruction of the previous segment. Branch/trace prediction in this context may predict entire traces for segments or for portions of segments, or predict the outcome of individual branch instructions.

In some embodiments, processor 20 comprises a segment management module 64. Module 64 monitors the instructions that are being processed by the pipeline of processor 20, and constructs an invocation data structure, also referred to as an invocation database 68. Invocation database 68 divides the program code into portions, and specifies the flow-control traces for these portions and the relationships between them. Module 64 uses invocation database 68 for choosing segments of instructions to be processed, and instructing the pipeline to process them. Database 68 is typically stored in a suitable internal memory of the processor.

The configuration of processor 20 shown in FIG. 1 is an example configuration that is chosen purely for the sake of conceptual clarity. In alternative embodiments, any other suitable processor configuration can be used. For example, parallelization can be performed in any other suitable manner, or may be omitted altogether. The processor may be implemented without cache or with a different cache structure. The processor may comprise additional elements not shown in the figure. Further alternatively, the disclosed techniques can be carried out with processors having any other suitable microarchitecture. As another example, it is not mandatory that the processor perform register renaming.

In various embodiments, the techniques described herein may be carried out by module 64 using database 68, or it may be distributed between module 64, module 60 and/or other elements of the processor. In the context of the present patent application and in the claims, any and all processor elements that control the pipeline so as to carry out the disclosed techniques are referred to collectively as “control circuitry.”

Processor 20 can be implemented using any suitable hardware, such as using one or more Application-Specific Integrated Circuits (ASICs), Field-Programmable Gate Arrays (FPGAs) or other device types. Additionally or alternatively, certain elements of processor 20 can be implemented using software, or using a combination of hardware and software elements. The instruction and data cache memories can be implemented using any suitable type of memory, such as Random Access Memory (RAM).

Processor 20 may be programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Speculative Multi-Threading Over N Code Segments Using M Fetch Units, M<N

In some embodiments, the pipeline of processor 20 comprises only M fetch units, M≧1. In the context of the present patent application and in the claims, the term “fetch unit” (or interchangeably “fetching module”) refers to the basic hardware element that fetches instructions from memory to be processed. In each clock cycle, a single fetch unit may fetch a single instruction, or a predefined number (e.g., 4 or 8) of successive instructions belonging to the same segment. In an example embodiment M=1. In other embodiments, M may equal 2, 3, 4, or any other suitable number.

Even though the number of fetch units is only M, segment management module 64 is able to invoke and handle N segments in parallel, N>M. In an example embodiment, M=1 and N=2. In other embodiments, however, any other suitable values of M and N can be used. For example, a single fetch unit (M=1) can be used to alternate among 3 or 4 segments (N=3 or N=4). As another example, two fetch units (M=2) can be used to alternate among 3 segments (N=3).

In some embodiments, in any clock cycle, the pipeline is able to decode, per fetch unit, only instructions belonging to the same segment. In some embodiments, in any clock cycle, the pipeline is able to rename, per fetch unit, only instructions belonging to the same segment.

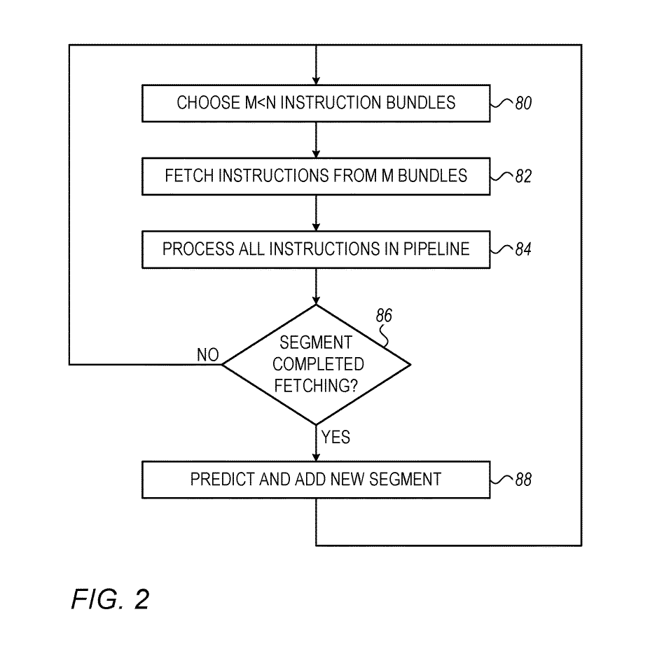

FIG. 2 is a flow chart that schematically illustrates a method for speculative multi-threading, in accordance with an embodiment of the present invention. In the present example, the total number of segments from which instructions can be fetched alternately at a given time is denoted N. The number of fetch units is denoted M. The M fetch units fetch instructions alternately from the N segments. In the present context, the term “alternately” means that, at any given point in time, unit 64 holds up to N identifiers (e.g., program counter values) of up to N segments from which instructions may be fetched.

The method begins with module 64 of processor 20 choosing M bundles of instructions to be fetched in the current clock cycle, at a bundle selection step 80. The number of bundles (M) is smaller than the number of segments from which instructions may be fetched (N). As noted above, each bundle may comprise a single instruction, or a predefined number of successive instructions belonging to the same segment. At a fetching step 82, the M fetch units fetch the instructions in the chosen bundles. At a processing step 84, the pipeline processed the various instructions flowing through it (including the newly-fetched instructions, and any previous instructions that are still in the pipeline).

At a fetching completion checking step 86, module 64 checks whether fetching of instructions is completed for any of the N segments. Fetching of instructions may be completed, for example, when the last instruction of the segment has been fetched, or when the segment is flushed in response to branch mis-prediction detected in a previous segment.

Consider, for example, a first segment and a second segment that occurs later in the code than the first segment. If the processor's control circuitry (e.g., unit 64) identifies a branch mis-prediction in the second segment, unit 64 will typically flush the instructions of the second segment that follow the branch mis-prediction from the pipeline. Unit 64 will, however, retain the instructions of the first segment in the pipeline. Note that, due to the out-of-order processing, some instructions of the first segment may flow in the pipeline after the mis-predicted branch instruction of the second segment. Nevertheless, these instructions will not be flushed since they belong to the first segment.

If no segment has completed fetching, the method loops back to step 80 above. If fetching is completed for one of the N segments, module 64 adds a new segment in its place to the list of N segments from which instructions may be fetched, at a segment replacement step 88. The method loops back to step 80 above.

Typically, module 64 adds the new segment based on a prediction of one or more future flow-control trace that are expected to be traversed through the program code. This prediction is carried out by module 60. Trace prediction techniques that can be used for this purpose are addressed, for example, in U.S. patent application Ser. Nos. 14/578,516, 14/583,119 and 14/637,418, cited above.

The process of FIG. 2 typically progresses continuously. The identities of the segments being processed changes over time, e.g., as some segments may complete fetching and some segments may be flushed due to branch mis-prediction. Typically but not necessarily, all the segments being processed belong to a single software thread.

FIG. 3 is a block diagram that schematically illustrates a processor pipeline, in accordance with an embodiment of the present invention. In the present example, the pipeline of processor 20 comprises only a single fetch unit 28, i.e., M=1. The pipeline further comprises a single decoding unit 32 and a single renaming unit 36.

In this configuration, segment management unit 64 instructs the single fetch unit to fetch instructions alternately from two segments denoted SEGMENT 1 and SEGMENT 2, belonging to the same software thread, i.e., N=2. Fetch unit 28 will therefore fetch some instructions from SEGMENT 1, then some instructions from SEGMENT 2, then again some instructions from SEGMENT 1, and so on. Example criteria that can be used by unit 64 for deciding when to stop fetching from SEGMENT 1 and switch to fetching from SEGMENT 2, and vice versa, are described further below.

The instructions flow along the pipeline in the order in which they were fetched. As can be appreciated, this order is different from the order-of-appearance of the instructions in the program code (and the logical processing order of the instructions, in accordance with the possibly-data-dependent flow control of the code). Decoding unit 32 and renaming unit 36 process the instructions in order of arrival. In some embodiments, in order to correctly rename instructions that arrive out-of-order, processor 20 uses out-of-order renaming schemes such as described, for example, in U.S. patent application Ser. Nos. 14/924,833 and 14/960,385, cited above.

In the example of FIG. 3, the pipeline comprises two Reorder Buffers (ROBs) 44. One ROB is assigned to buffer the instructions of SEGMENT 1, and the other ROB is assigned to buffer the instructions of SEGMENT 2. From the two ROBs, the instructions are dispatched for execution by execution units 52. In this example, the same set of execution units 52 is shared by both segments.

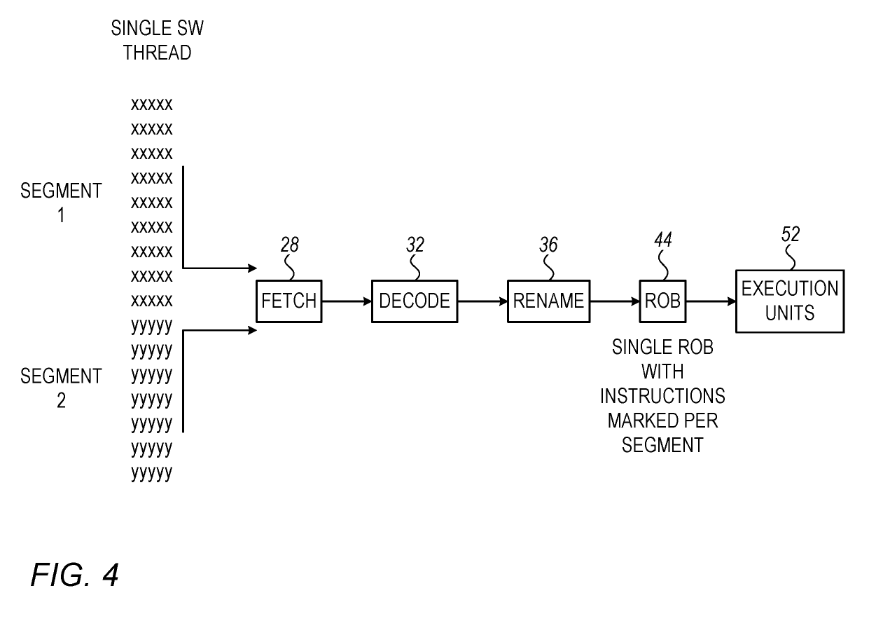

FIG. 4 is a block diagram that schematically illustrates a processor pipeline, in accordance with another embodiment of the present invention. The configuration of FIG. 4 differs from the configuration of FIG. 3 in that the pipeline comprises a ROB 44 that is shared by SEGMENT 1 and SEGMENT 2. In other words, a single ROB is used for buffering the instructions of both segments. Typically, the instructions in the ROB are marked with suitable indications that indicate which instruction belongs to which segment.

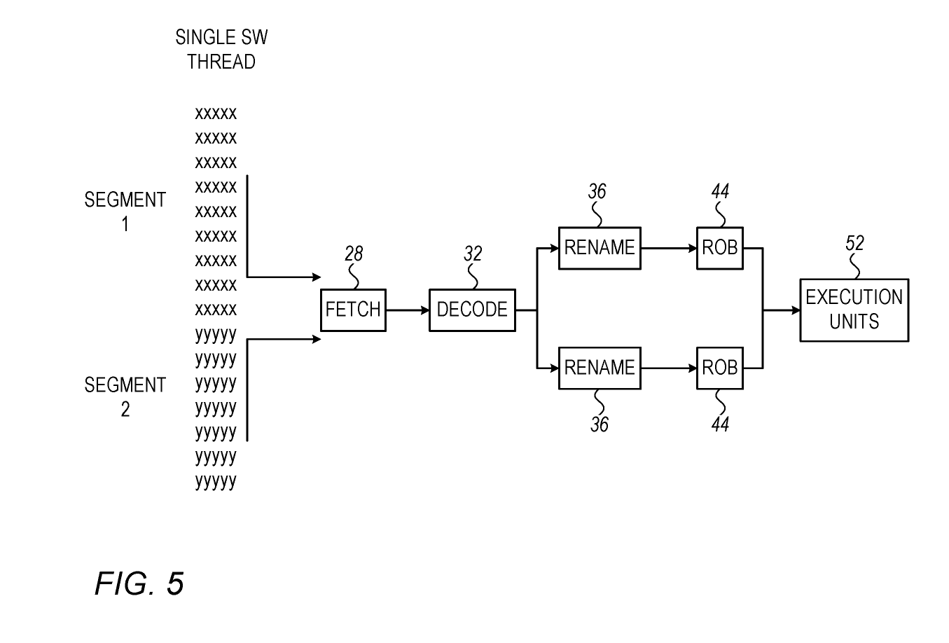

FIG. 5 is a block diagram that schematically illustrates a processor pipeline, in accordance with an alternative embodiment of the present invention. In this example, both renaming and ROB buffering are separate per segment. The pipeline comprises two renaming units 36, one assigned to rename the instructions of SEGMENT 1 and the other assigned to rename the instructions of SEGMENT 2. The pipeline further comprises two ROBs 44, one assigned to buffer the instructions of SEGMENT 1 and the other assigned to buffer the instructions of SEGMENT 2. Nevertheless, the instructions of both segments are dispatched for execution by the same set of execution units 52.

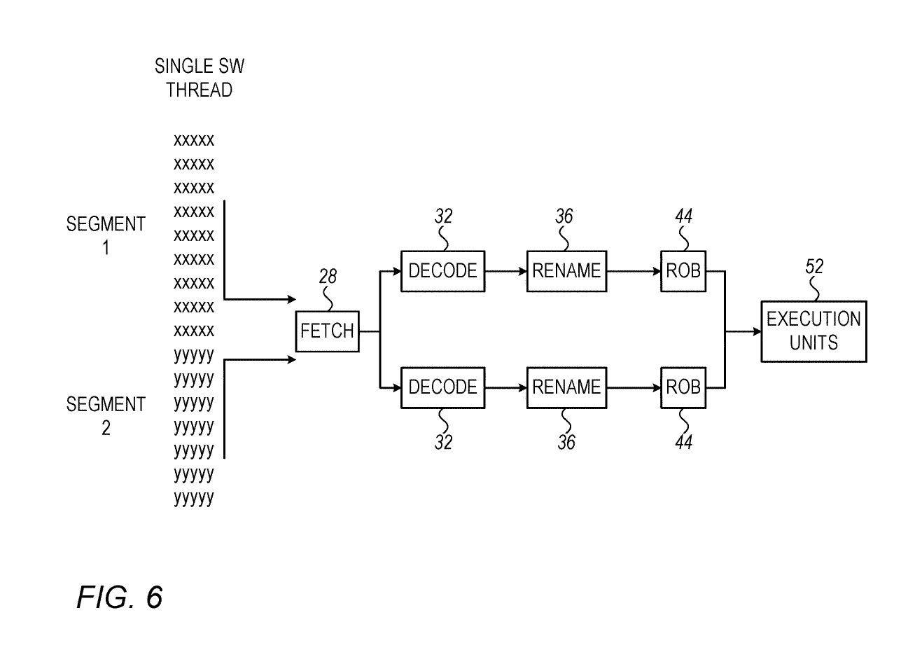

FIG. 6 is a block diagram that schematically illustrates a processor pipeline, in accordance with yet another embodiment of the present invention. In the example of FIG. 6, the pipeline comprises only a single fetch unit 28, but separate decoding units 32, renaming units 36 and ROBs 44 per segment. Execution is again shared by the same set of execution units.

The pipeline configurations shown in FIGS. 3-6 above are example configurations that are depicted purely for the sake of conceptual clarity. In alternative embodiments, any other suitable pipeline configuration can be used. For example, the pipeline may comprise a respective dedicated set of execution units per segment. As another example, the pipeline may comprise a register file that is shared by at least two of the segments.

### Alternation Between Segments

In various embodiments, segment management module 64 may apply various criteria or policies for deciding how and when to alternate between segments when fetching instructions.

For example, module 64 may assign different priorities to different segments, and alternate the fetching operations between segments in accordance with the priorities. Priorities can be assigned due to various reasons. For example, a segment experiencing instruction-cache or data-cache miss events (or predicted to experience such cache-miss events) may be given low priority, so that fetching can proceed from other segments. As another example, an older segment (occurring earlier in the code) can be given higher priority than a newer segment (occurring later in the code). As yet another example, a segment whose ROB is filled beyond a certain threshold can be given lower priority relative to a segment whose ROB is emptier. Alternating the fetching operations between segments in accordance with the priorities can be carried out in various ways. For example, module 64 may allocate higher fetch bandwidth to a segment having a higher priority, and vice versa.

As another example, module 64 may identify that fetching from one of the segments is stalled, or is predicted to be stalled, for at least one clock cycle. In response, module 64 may temporarily suspend fetching instructions from that segment and instruct the pipeline to fetch instructions only from other segments. More generally, module 64 may decide to switch from fetching instructions from a first segment to fetching instructions from a second segment in response to a stall (or expected stall) on any suitable resource in the first segment. Such resources may comprise, for example, a certain ROB becoming full, data-cache miss or instruction-cache miss.

As another example, module 64 may decide to switch from fetching instructions from a first segment to fetching instructions from a second segment in response to an indication that the second segment belongs to a critical execution path. In the present context, the term “critical execution path” refers to a sequence of instructions that, if delayed, would delay the overall execution time of the code. An indication that a certain segment belongs to a critical execution path may be provided, for example, by module 60 based on past monitoring of the code.

As yet another example, module 64 may decide to switch from fetching instructions from a first segment to fetching instructions from a second segment in accordance with any suitable predefined fairness criterion. Such a fairness criterion would typically aim to ensure that all segments are being processed and no single segment consumes all fetching resources. Example fairness criteria would alternate from one segment to another periodically (e.g., every certain number of cycles, or coarser-granularity period).

One of the consequences of alternating fetch units between segments is that a certain renaming unit 36 may be required to alternate between segments, as well. In some embodiments, the renaming unit renames registers by maintaining a mapping that maps architectural registers (specified in the processor instruction set architecture) to respective physical registers. In an embodiment, when switching from a first segment to a second segment, the renaming unit saves the up-to-date mapping of the first segment, and retrieves the saved mapping of the second segment. Further aspects of architectural-to-physical register mapping, and of switching between different mappings, are addressed in U.S. patent application Ser. Nos. 14/924,833 and 14/960,385, cited above.

In some embodiments, the pipeline fetches and processes simultaneously from segments belonging to two (or more) different software threads. In one example embodiment, the pipeline comprises multiple fetch units 28, at least one of which fetches instructions out-of-order. In some embodiments, this sort of operation is carried out only part of the time. In other words, at a given time at least one fetch unit is used to fetch instructions from independent threads, and at another time this fetch unit fetches instructions out of order.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A processor, comprising:
a pipeline, which is configured to process instructions of program code and comprises one or more fetch units; and
control circuitry, which is configured to:
predict at run-time one or more future flow-control traces to be traversed in the program code;
define, based on the predicted flow-control traces, two or more regions of the program code from which instructions are to be fetched, wherein the number of regions is greater than the number of fetch units; and
instruct the pipeline to fetch instructions alternately from the two or more regions of the program code using the one or more fetch units, and to process the fetched instructions.

2. The processor according to claim 1, wherein the control circuitry is configured to hold, at any given time, identifiers of the two or more regions, and to instruct the one or more fetch units to fetch instructions from a partial subset of the two or more regions in a given clock cycle.

3. The processor according to claim 1, wherein, in any clock cycle of the processor, fetching is performed from only one of the regions per any one of the fetch units.

4. The processor according to claim 1, wherein the number of fetch units is 1 and the number of regions is 2.

5. The processor according to claim 1, wherein the control circuitry is configured to instruct the fetch units to fetch the instructions in an order, which differs from an actual order of processing of the instructions determined by an actual flow control through the program code.

6. The processor according to claim 1, wherein the control circuitry is configured to assign one of the regions higher priority than another of the regions in fetching the instructions.

7. The processor according to claim 1, wherein the control circuitry is configured to identify that fetching from one of the regions is stalled or is predicted to be stalled for at least one clock cycle, and in response instruct the fetch units to fetch only instructions from other regions.

8. The processor according to claim 1, wherein, in any clock cycle, the pipeline is configured to decode, per fetch unit, only instructions belonging to the same region.

9. The processor according to claim 1, wherein, in any clock cycle, the pipeline is configured to rename, per fetch unit, only instructions belonging to the same region.

10. The processor according to claim 1, wherein the pipeline comprises a respective reorder buffer (ROB) for each of the regions.

11. The processor according to claim 1, wherein the pipeline comprises a reorder buffer (ROB) that is shared by at least two of the regions.

12. The processor according to claim 1, wherein the two or more regions comprise a first region, and a second region that occurs later in the program code than the first region, and wherein the control circuitry is configured to identify a branch mis-prediction in the second region, and in response flush from the pipeline the instructions that follow the branch mis-prediction in the second region, but retain the instructions of the first region in the pipeline.

13. The processor according to claim 1, wherein the pipeline comprises a separate set of execution units for each of the regions.

14. The processor according to claim 1, wherein the pipeline comprises a set of execution units that is shared by at least two of the regions.

15. The processor according to claim 1, wherein the pipeline comprises a register file that is shared by at least two of the regions.

16. The processor according to claim 1, wherein the control circuitry is configured to decide to switch from fetching the instructions from a first region to fetching the instructions from a second region in response to a stall or predicted stall on a resource in the first region.

17. The processor according to claim 1, wherein the control circuitry is configured to decide to switch from fetching the instructions from a first region to fetching the instructions from a second region in response to an indication that the second region belongs to a critical execution path.

18. The processor according to claim 1, wherein the control circuitry is configured to decide to switch from fetching the instructions from a first region to fetching the instructions from a second region in accordance with a predefined fairness criterion.

19. A method, comprising:
in a processor that processes instructions of program code and comprises one or more fetch units, predicting at run-time one or more future flow-control traces to be traversed in the program code;
defining, based on the predicted flow-control traces, two or more regions of the program code from which instructions are to be fetched, wherein the number of regions is greater than the number of fetch units; and
fetching instructions alternately from the two or more regions of the program code using the one or more fetch units, and processing the fetched instructions.

20. The method according to claim 19, wherein fetching the instructions alternately from the two or more regions comprises holding, at any given time, identifiers of the two or more regions, and instructing the one or more fetch units to fetch instructions from a partial subset of the two or more regions in a given clock cycle.
